(19) United States
(12) Patent Application Publication
(10) Pub. No.: US 2002/0092135 A1
(43) Pub. Date: Jul. 18, 2002

(54) Portable safety seat thread through

(76) Inventors: Robert Mancini, Bedford, NY (US); Arthur R. Fried, Boynton Beach, FL (US); Beverly Fried, Boynton Beach, FL (US)

Correspondence Address: Charles N J. Ruggiero, Esq., Ohlandt, Greeley, Ruggiero & Perle, L.L.P., 10th Floor, One Landmark Square, Stamford, CT, 06901-2682, US

(21) Appl. No.: 10/029,136

(22) Filed: Dec. 20, 2001

Related U.S. Application Data
(60) Provisional application No. 60/256,795, filed on Dec. 20, 2000.

(51) Int. Cl. F16G 3/02

(52) U.S. Cl. 24/33 R; 24/35

(57) ABSTRACT

The present invention provides a method for facilitating the installation of a safety seat and device therefore. A thread through tool is provided to guide a seat belt. The thread through tool can be formed into a handle and a clasp in which the handle can be inserted through a safety seat and pulled, such that a seat belt clasped in a clasp portion of the tool will be more easily inserted through a proper installation path of a safety seat. The thread through tool can be fashioned from a semi-rigid strip with various portions adapted to form hinged portions and fastening areas strategically placed to facilitate formation of the tool from the strip. The fastening area can include hook and loop material or other easy fastening means.

### CLAIM OF PRIORITY

This patent application claims priority under 35 U.S.C. §119(e) from US Provisional Patent Application 60/256,795, filed Dec. 20, 2000.

### BACKGROUND OF THE INVENTION

1. Field of the Invention

The present invention relates to a device and method for facilitating the installation of a child's safety seat in an automobile. In particular, the present invention relates to a portable thread through device to aid the insertion of an auto seat belt through the proper channel of a child's car seat.

2. Description of the Prior Art

Traditionally, a level of frustration has accompanied the installation of a child's automobile safety seat. Typically, a safety seat is designed to be placed on the rear seat of an automobile and secured by pushing a car seat belt through an open slot or channel located in the back of the safety seat. Difficulty arises when the non-rigid seat belt must be threaded through a relatively narrow slot or channel. In addition, the width of the car seat makes it difficult to reach around and pull the seat belt through a far end of the channel in the car seat.

Exasperation can result from trying to grasp an end of the care safety belt buckle to guide it through the back of the safety seat. A hand can even become bruised or scratched, and fingernails split or broken, during unaided installation of a child's safety seat. A medical condition making it hard to bend over a rear seat, such as the mother who has recently given birth, can further complicate the installation of a safety seat. With over 3 million children currently being born in the United States each year, the odds of a child being injured due to an improperly installed safety seat increases.

Difficulty during an attempted installation can also result in a safety seat not being properly installed. Improper installation may give a false assurance as to a level of safety being provided for a child strapped into a safety seat. In the event of an accident, an improperly installed safety seat can result in injury or even death of a child.

Therefore, what is needed is a device that aids in the proper installation of children's safety seat into an automobile or other vehicle, and a method to quickly, efficiently and easily install a children's safety seat.

### SUMMARY OF THE INVENTION

It is an object of the present invention to provide a device facilitating the installation of a child's safety seat. It is another object of the present invention to provide such a seat that comprises: a semi-rigid strip having a first end and a second end, in which the first hinge enables the formation of clasp, and the second hinge enables the formation of a handle. It is yet another object of the present invention to provide such a seat in which at least two hinges can be formed between the first end and the second end.

It is a further object of the present invention to provide such a device in which the semi-rigid strip is made of plastic, vinyl, hard rubber, heavy fiberboard, cardboard, or leather.

It is still a further object of the present invention to provide such a device in which the semi-rigid strip comprises a plastic made of acrylonitrile butadiene styrene, polyvinyl chloride, polyethylene, polypropylene, polyacrylate, polystyrene, polycarbonate, polyethylene terephthalate, polybutylene terephthalate, nylon or any mixtures thereof. In a preferred embodiment, the semi-rigid strip is made of acrylonitril butadiene styrene or polyvinyl chloride.

It is an embodiment of the present invention to provide a device as described above, in which the first end of the semi-rigid strip folds over at the hinge and is attached to the semi-rigid strip to form a handle. The hinge is preferably scored. The means for forming the handle includes a hook and loop system, a snap, an adhesive area, and a hook and eye system.

It is another object of the present invention to provide a device as described above in which the second end of the semi-rigid strip folds over by the hinge and is attached to the semi-rigid strip to form a clasp. The means for forming the clasp includes a hook and loop system, a snap, an adhesive area, and a hook and eye system. In a preferred embodiment, the second end is an extension. The extension can be straight, T-shaped or L-shaped.

It is yet a further object of the present invention to provide such a device which further comprises a third hinge, in which the first end of the semi-rigid strip folds over at the third hinge and is attached to the semi-rigid strip to form a storage configuration. The means for forming the storage configuration includes a hook and loop system, a snap, an adhesive area, and a hook and eye system.

It is still yet a further object of the present invention to provide a method for facilitating the installation of a safety seat, the method comprising: (a) forming a handle at one end of a semi-rigid strip; (b) forming a clasp at a second end of the semi-rigid strip and clasping a male portion of a seat belt buckle within said clasp; (c) directing the handle through a path for securing a safety seat; (d) unclasping the male portion of the seat belt buckle; and (e) buckling the male portion to the female portion of the seat belt.

It is also an object of the present invention to provide such a method, which further comprises folding the semi-rigid strip into a storage configuration in which a first and second portion of the semi-rigid strip is folded over a body portion of the semi-rigid strip.

### BRIEF DESCRIPTION OF THE DRAWINGS

FIG. 1 shows one embodiment of the thread through device;

FIG. 2 illustrates a side view of the thread through device of FIG. 1;

FIG. 3 illustrates a side view of the thread through device of FIG. 1 in a folded condition;

FIG. 4 shows a second embodiment of the thread through device;

FIG. 5 is an exploded view of the thread through device having a T-shaped extension portion of FIG. 2;

FIG. 6 depicts a third embodiment of the thread through device having a T-shaped extension portion and one hinge; and

FIG. 7a-c illustrates a method for utilizing a thread through device to facilitate installation of a safety seat of the present invention.

### DETAILED DESCRIPTION OF THE INVENTION

The present invention provides a method for facilitating the installation of a child's safety seat. The present invention also provides a thread through tool to clasp a seat belt. The thread through tool can be formed into a handle and a clasp. The handle can be inserted though a safety seat and pulled, such that a seat belt clasped in a clasp portion of the tool will be more easily inserted through a proper installation path of a safety seat.

The thread through device provides a semi-rigid tool to aid in the threading process of the seat belt through the car seat channel. The thread through tool can be fashioned from a semi-rigid strip with various portions scribed to form hinged portions and fastening areas strategically placed to facilitate formation of the tool from the strip. The fastening area can include hook and loop material, or other easy fastening means.

The thread through device can be collapsible for easy storage following the installation. To conveniently store the thread through tool, it can be folded and formed into a storage configuration. With simple folding action, the thread through tool can be reformed into a configuration that includes a handle and a clasp. The clasp can be inserted through an opening in a seat belt buckle and fastened, thereby attaching the buckle to the thread through tool. The handle can then be directed through a proper channel or slot suitable for securing the seat belt. The seat belt in turn secures the safety seat into a vehicle.

After the seat belt has been properly threaded through the channel in the safety seat, the clasp can be easily unfastened. The thread through tool can then be reconfigured into a storage configuration and stored.

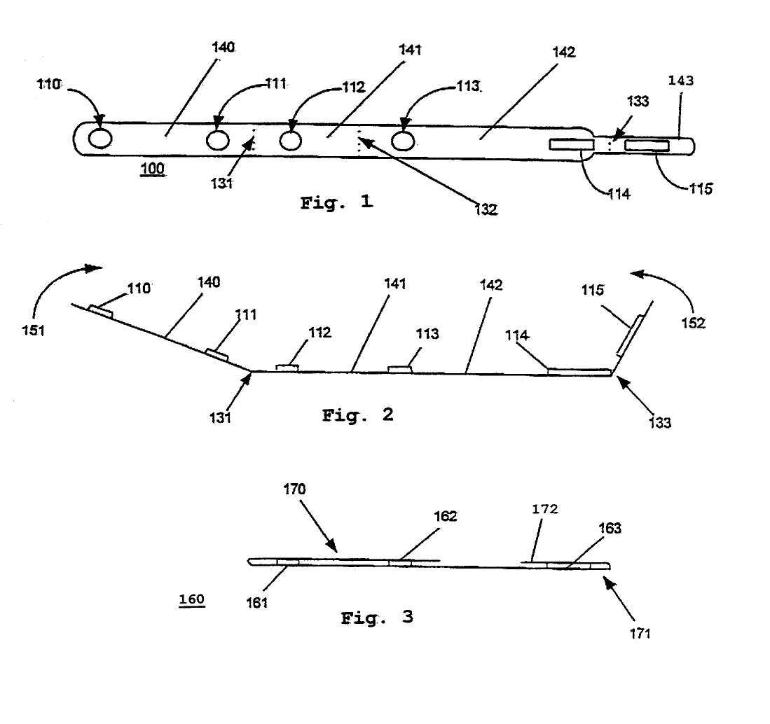

FIG. 1 is a first embodiment of a thread through device of the present invention generally experimented by reference numeral 100. The thread through device 100 can be a semi-rigid strip formed into two or more semi-rigid body portions 140-143 attached with a two or more of hinges 131-133. In one preferred embodiment, the thread through device 100 is a single plastic, such as polyethylene or PVC, formed into a body 100 with two or more scores 131-133 acting as the hinges and also fashioning the single body 100 into separate semi-rigid body portions 140-143.

In other embodiments, the device is made of other plastics such as acrylonitrile butadiene styrene (ABS) plastic, cardboard or metal strip, such as aluminum, or steel. The semi-rigid strip may be scored or include mailing tape in particular areas for reinforcement.

The thread through device 100 includes fastening areas 110-115 to hold the semi-rigid body portions 140-143 in place during installation of the auto seat belt through the car seat. The fastening areas 110-115 preferably include an area of hook and loop fastener, a snap, an adhesive area, hook and eye, or portions 140-143 in place. any other known fastener capable of holding the semi-rigid

In the embodiment of FIG. 1, the semi-rigid strip has rounded edges. The device has a width that ranges between about 0.5 inch to about 3 inches, and preferably between about 1.0 inch to about 2.5 inches. The device has a length between about 11 inches to about 22 inches, and preferably between about 12 inches and about 14 inches. More preferably, the length of the device is between about 13 inches and about 13.5 inches. The thread through device includes at least one hinge. The length of the hinge from one end varies with each embodiment. The width of the clasp ranges between about 0.25 to about 1.0 inch and preferably between about 0.5 inch. The width can also taper and therefore vary within the same embodiment. The length of the clasp is approximately ⅙ the size of the main portion, and ranges between about 0.75 inch to about 2.0 inches and preferably about 1.0 inch.

Referring now to FIG. 2, during installation, the thread through device 100 can be bent or folded over at the hinged portion 131 until a first semi-rigid portion 140 is positioned approximately parallel to an adjacent semi-rigid portions 141 and a body portion 142 to form a handle section. Similarly, a more narrow portion at one extremity of the semi-rigid strip 143 can be made to fold over, or bend, along the hinged portion 133 until it is approximately parallel with an adjacent semi-rigid body portion 142, thereby forming a clasping section 172.

Fastening area 110-115 can be aligned as a result of the bending process such that fastening means 110 aligns with fastening area 113, and fastening area 111 aligns with fastening area 112. In addition, fastening area 115 can align with fastening area 114.

The mating of a fastening area 110 with another fastening area 113 can form a fastened joint 162. The mating of fastener 111 with fastener 112 forms a fastened joint 161 as shown in FIG. 3.

In addition, the mating of fastener 114 with fastener 115 can result in a fastened joint 163.

The formation of fastened joints 161, 162 can position a first semi-rigid body portion 140 such that it is secured to a second semi-rigid body portion 141 and a third semi-rigid body portion 142. The first body portion can span the hinged portion 132 and be secured to the second semi-rigid body portion 141 and the third semi-rigid body portion 142. The hinged portion 132 can be held in a set position as a result of the first body portion spanning it. When the first body portion is properly positioned and fastened, the semi-rigid body portion 141 and semi-rigid body portion 142 can be essentially planar as shown in FIG. 3.

Similarly, the formation of fastened joints 163 can position an end most semi-rigid body portion 143 such that it is secured to a third semi-rigid body portion 142. When all three fastened joints 161-163 are formed, the thread through tool takes on a threading configuration 160 suitable for use in installing a child's safety seat.

To facilitate storage of the thread through device, the thread through tool can be made to bend at hinged portion 132 such that the first semi-rigid body portion 140 and the second semi-rigid body portion 141 are essentially parallel to the third semi-rigid body portion 142 as shown in FIG. 1. With the first semi-rigid body portion 140 and the second semi-rigid body portion 141 parallel to the third semi-rigid body portion 142, the thread through device is fashioned into a storage configuration 160.

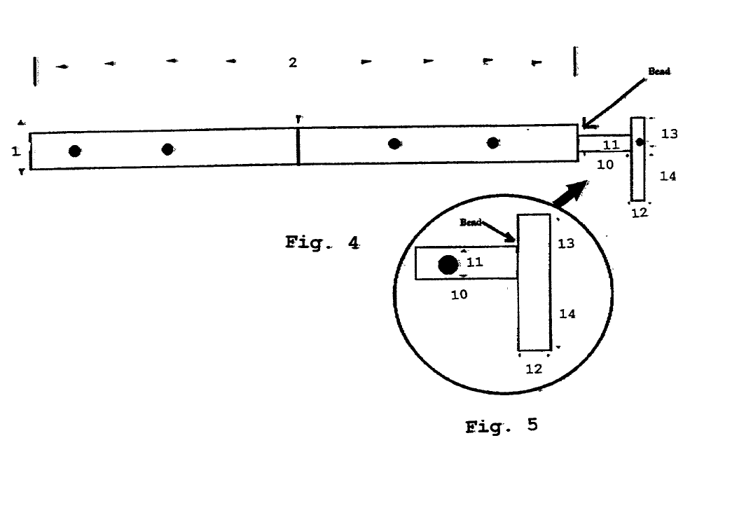

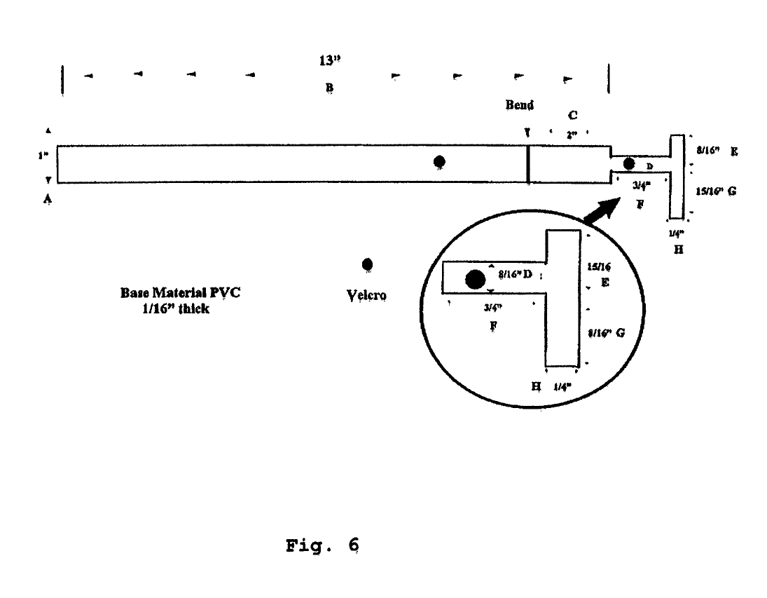

FIGS. 4 and 6 depict embodiments of the thread through device having a T-shaped extension.

FIG. 4 has a hinge in the midsection of the semi-rigid strip so that when the strip folds over, it is half the length. The T-shaped extension is therefore not folded onto a part of the semi-rigid strip. However, there are two additional hinges. One hinge is at the junction between the extension and the semi-rigid strip so that the extension may fold over onto the semi-rigid strip. The other hinge or bend is at the cross-section of the T-shaped extension. This embodiment as a number of fastening areas (five in total) that can be used to secure each bend of a hinge.

In this embodiment, the semi-rigid strip has straight edges. This embodiment has similar dimensions as FIG. 1 for the width and length of the device, and the length of the hinge from one end. However, the clasp for this embodiment is T-shaped. The length 10 that runs parallel to the length of the thread through device ranges from about 0.5 inch to about 1.5 inches and preferably 0.75 inch to about 1.0 inch. The width 11 of the clasp that runs parallel to the length of the thread through device is from about 0.25 to about 1.0 inch and preferably about 0.5 inch. The width 12 of the T-shaped clasp that runs perpendicular to the length of the thread through device ranges from about 0.125 to about 0.5, preferably from about 0.2 inch to about 0.3 inch, and more preferably about 0.25 inch. The two lengths 13 and 14 for the T-shaped clasp combined is the length the side of the T-shape that is perpendicular to the thread through device. The first length 13 includes the width 11 of the clasp that runs parallel to the length of the thread through device. The second length 14 does not include the width 11 of the clasp.

FIG. 6 has a T-shaped extension with only one hinge that is about two inches from the edge of the semi-rigid strip connected to the extension. This embodiment has two fastening areas so that the extension may be folded onto the semi-rigid strip.

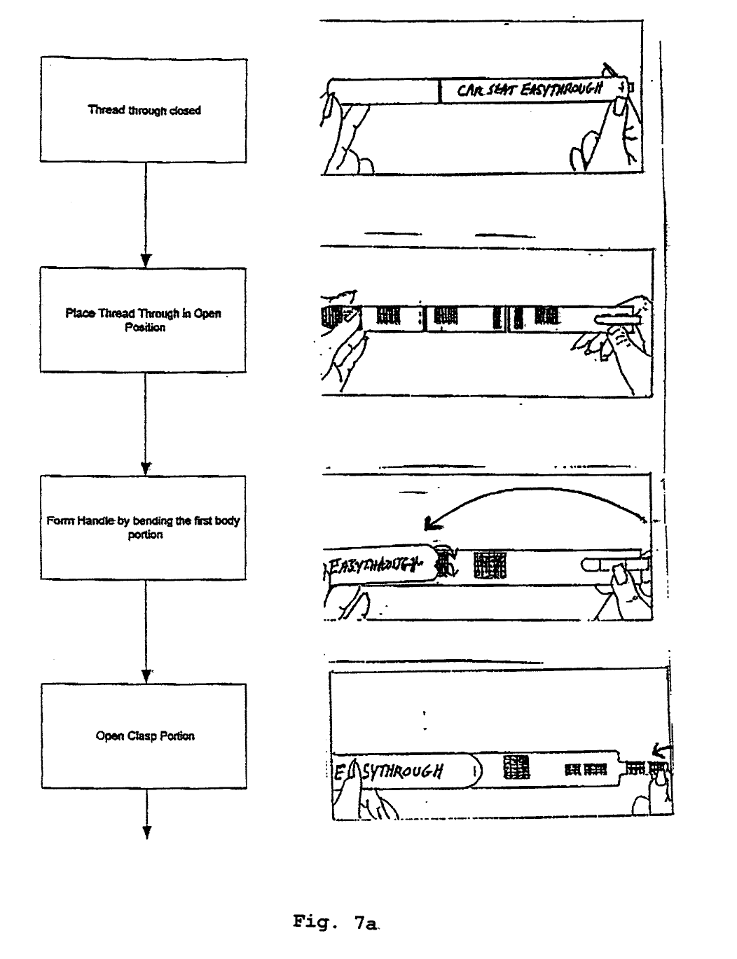

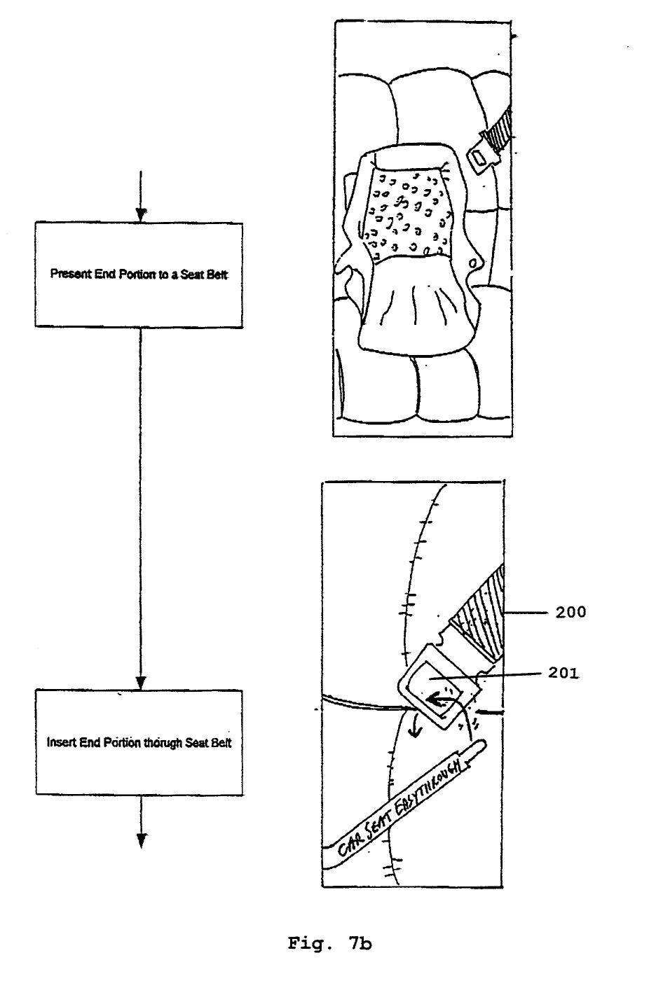

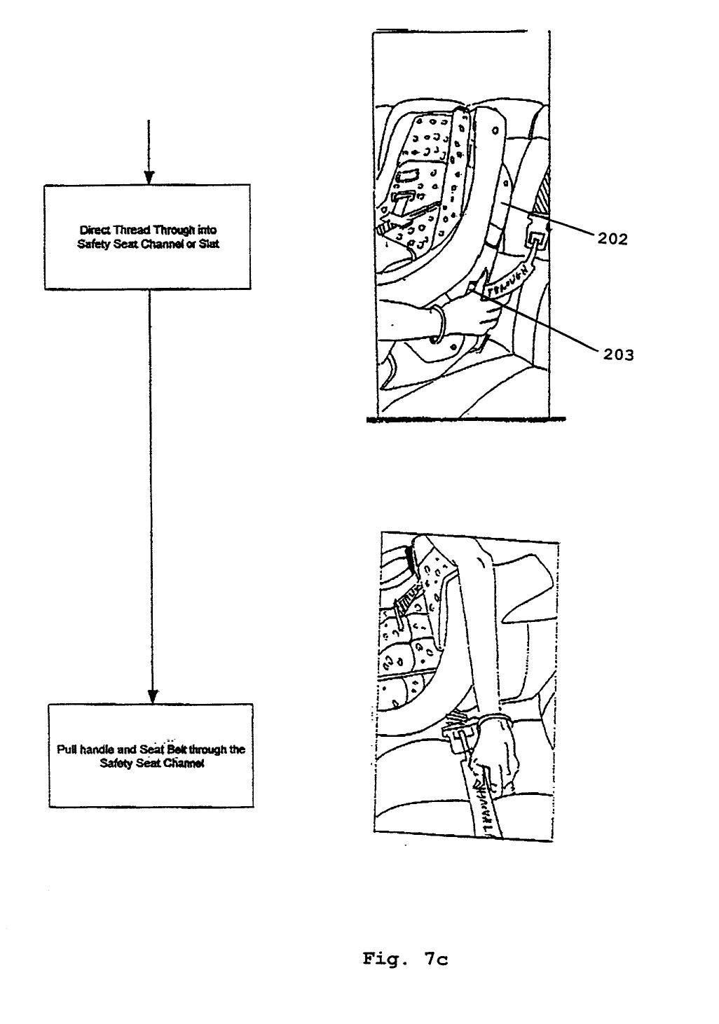

Referring now to FIGS. 7a-c, a method is shown illustrating how a thread through device 100 can be utilized to facilitate installation of a safety seat. The method can begin with the thread through device 100 in a closed position as shown in FIG. 1, or any other convenient position from which it can be placed in an open position with the fasteners unfastened. A handle can be formed by bending, or folding, a first semi-rigid body portion 140 at hinged portion 131 until first semi-rigid portion extends beyond the second hinged portion 132 and can be attached to the third body portion 142. In a preferred embodiment, the first semi-rigid body portion is semi-rigidly attached to the third semi-rigid body portion by fastening a first fastening area 110 to a fourth fastening area. Additional sturdiness can result from also attaching a second fastening area 111 to a third fastening area 112. Preferably, the second fastening area 111 is located on the first body portion 140, and the third fastening area 112 is located on the second body portion 141.

FIG. 7b demonstrates how the thread through device hooks onto the seat belt. The end most body portion 143 can be opened and presented to the buckle of a seat belt 200. The end most portion 143 can be inserted through a hole in the buckle 201. The end most portion 143 can be formed into a clasp 171 by bending at a hinged portion 133, which attaches the end most body portion 143 to an adjacent body portion 142. Mating a fastening area 115 on the end most portion 143 to a fastening area 114 on the adjacent body portion 142 can secure the clasp in the closed position in which the clasp 171 will be firmly attached to the seat belt buckle.

As shown in FIG. 7c, the handle portion 170 can then be directed into a channel in a side of an auto safety seat 202. Pulling the handle from a side of the safety seat opposite the side, into which the handle was directed, can guide the seat belt through the channel of the safety seat 203. Other embodiments can include directing the handle into a slat, slot, hook, or other securing mechanism on a safety seat meant to receive a seat belt.

After the seat belt has been pulled through the channel of the safety seat 203, the clasp of the thread through device can be unfastened and the seat belt can be buckled in the normal fashion. Additionally, the semi-rigid strip can be formed into a storage configuration wherein a first and second portions of the semi-rigid strip are folded over a body portion of the semi-rigid strip 160.

A number of embodiments of the present invention have been described. Nevertheless, it will be understood that various modifications may be made without departing from the spirit and scope of the invention. Therefore, other implementations are within the scope of the following claims.

What is claimed is:

1. A device facilitating the installation of a safety seat comprising:
a semi-rigid strip having a first end and a second end; at least two hinges between said first end and said second end,
wherein a first hinge enables the formation of clasp, and wherein a second hinge enables the formation of a handle.

2. The device as recited in claim 1, wherein said semi-rigid strip comprises a material selected from the group consisting of vinyl, plastic, hard rubber, heavy fiberboard, cardboard, and leather.

3. The device as recited in claim 1, wherein said semi-rigid strip comprises a plastic selected from the group consisting of acrylonitrile butadiene styrene, polyvinyl chloride, polyethylene, polypropylene, polyacrylate, polystyrene, polycarbonate, polyethylene terephthalate, polybutylene terephthalate, nylon, and any mixture thereof.

4. The device as recited in claim 1, wherein said semi-rigid strip comprises acrylonitrile butadiene styrene or polyvinyl chloride.

5. The device as recited in claim 1, wherein said first end of the semi-rigid strip folds over by said hinge and is attached to the semi-rigid strip by means for forming a handle.

6. The device as recited in claim 5, wherein said means for forming said handle is selected from the group consisting of a hook and loop system, a snap, an adhesive area, and a hook and eye system.

7. The device as recited in claim 1, wherein said second end of the semi-rigid strip folds over by said hinge and is attached to the semi-rigid strip by means for forming a clasp.

8. The device as recited in claim 7, wherein said means for forming said clasp is selected from the group consisting of a hook and loop system, a snap, an adhesive area, and a hook and eye system.

9. The device as recited in claim 7, wherein said second end includes an extension of the semi-rigid strip.

10. The device as recited in claim 9, wherein said extension is straight, T-shaped or L-shaped.

11. The device as recited in claim 1, further comprising a third hinge, wherein said first end of the semi-rigid strip folds over by said third hinge and is attached to the semi-rigid strip by a means for forming a storage configuration.

12. The device as recited in claim 11, wherein said means for forming said storage configuration is selected from the group consisting of a hook and loop system, a snap, an adhesive area, and a hook and eye system.

13. A method for facilitating the installation of a safety seat, the method comprising:
forming a handle at one end of a semi-rigid strip;
forming a clasp at a second end of the semi-rigid strip, and clasping a male portion of a seat belt buckle within said clasp;
directing the handle through a path for securing a safety seat;
unclasping the male portion of the seat belt buckle; and
buckling the male portion to the female portion of the seat belt.

14. The method as recited in claim 13, further comprising folding the semi-rigid strip into a storage configuration, wherein a first and second portion of the semi-rigid strip is folded over a body portion of the semi-rigid strip.

15. The installation of a child's safety seat by application of a semi-rigid strip comprising the steps of:
forming a handle at one end of the semi-rigid strip;
forming a clasp at a second end of the semi-rigid strip, and clasping a male portion of a seat belt buckle within said clasp;
directing the handle through a path for securing a safety seat;
unclasping the male portion of the seat belt buckle; and
buckling the male portion to the female portion of the seat belt.
